(19) United States
(12) Patent Application Publication
(10) Pub. No.: US 2008/0148644 A1
(43) Pub. Date: Jun. 26, 2008

(54) WATER LOCK BARRIER FOR PREVENTING FLOOD DAMAGE

(76) Inventor: Mark J. Valente, St. Petersburg, FL (US)

Correspondence Address: LARSON AND LARSON, 11199 69TH STREET NORTH, LARGO, FL, 33773, US

(21) Appl. No.: 11/613,623

(22) Filed: Dec. 20, 2006

(51) Int. Cl. E06B 7/18

(52) U.S. Cl. 49/466

(57) ABSTRACT

An application for a flood guard for protecting an opening of a building from high water includes a groove extending longitudinally across the front of the opening of the building and partially up each of two sides of the opening. An impermeable sheet sized to cover at least a lower portion of the opening is removably held in the groove by a spline, thereby at least partially covering the opening of the building and preventing high-water from entering the building through the opening.

### BACKGROUND OF THE INVENTION

1. Field of the Invention

This invention relates to the field of reducing damage from flood water and more particularly to an apparatus for preventing water from entering buildings through doors and windows.

2. Description of the Related Art

Many buildings and houses are located in areas prone to flooding. Often, heavy rains cause rivers to overflow their banks or coastal storms send storm surges far inland. Many homes and businesses are damaged from water levels reaching a doorway or window. Because most doors and windows are not watertight, often water seeps into the building damaging floors, carpets, drywall and possessions.

Many try to prevent damage by installing a shield or water barrier. The most common solution is to install a sturdy, planar sheet of material such as plywood over the door or window. This solution prevents piercing of the structure by flying objects during high winds, but is only slightly effective against water seepage unless the planar sheet is well caulked. This solution is inadequate because many residences and businesses don't have sufficient space to store the planar material after the storm water recedes, it requires someone skilled in carpentry and strong enough to carry and position the planar material and, the installation of such impacts the frame and aesthetic appearance of the door or window on which it is installed.

Another attempt at solving this problem is sandbags. Sandbags are usually burlap bags that hold around 50 pounds of sand and, after being stacked around a door or other place water can enter, help keep water away from such entryway. Sandbags are especially helpful in river areas where the water flows because they can stand up to such pressure, but less effective when the high water remains for long periods of time because they are porous and often allow small amounts of water to penetrate their barrier. As with planar sheets, the installation of sandbags is difficult for many because of their weight and once used, the set sand is difficult to properly dispose and often the bags are not reused.

Several improvements have been made to solve this problem, often using solid sheets of plastic or Plexiglas. For example, U.S. Pat. No. 6,591,553 to Vaughn describes an entryway barrier having a telescopic frame, locks to hold the frame securely in the opening (door frame) and a sheet of plastic that fits within the frame to block the water. Since the frame is placed in the opening, without caulking, water can penetrate this barrier. Furthermore, the frame and plastic sheet must be sized appropriately with tight tolerances for the door. In addition, when not in use, the planar sheets of plastic and frame must be stored.

A similar device is shown in U.S. Pat. No. 3,861,081 to Maskell. This is similar to the '553 patent, except its frame goes on the outside surface of the entryway instead of within the entryway. By such installation, the frame doesn't interfere with the entryway and can, therefore, be left installed until needed. The planar sheet still creates a storage issue and, even though the frame can remain installed, it detracts from the aesthetic look of the building on which it is installed.

A similar device is shown in U.S. Pat. No. 5,077,945 to Koeniger. The device of this patent also has to be sized to tight tolerances and has the same storage issues.

A slightly different approach is taken in U.S. Pat. No. 6,460,299 to Burrow, in which a plastic sheet is used as the barrier and is held in place with bars and tubes. The plastic sheet is somewhat sealed at the bottom by passing it under a water weight. Although storage of the plastic sheet is very efficient, the rest of the frame and water weight must be stored and re-installed for each use. Furthermore, once the water rises above the water weight, the water weight becomes less and less effective for keeping water from seeping under the plastic sheet because it has basically the same specific gravity as water.

What is needed is an apparatus that reduces water damage from high water that stores efficiently and is easy and quick to install and take down.

### SUMMARY OF THE INVENTION

In one embodiment, a flood guard for protecting an opening of a building from high water is disclosed including a groove extending longitudinally across the front of the opening of the building and partially up each of two sides of the opening. An impermeable sheet sized to cover at least a lower portion of the opening is removably held in the groove by a spline, thereby at least partially covering the opening of the building and preventing high-water from entering the building through the opening.

In another embodiment, a method of protecting an opening of a building from high-water is disclosed including affixing a frame section around the lower outside perimeter of the opening, the frame section having at least one exposed groove extending longitudinally from one end of the frame section to a far end of the frame section. An impermeable sheet that is wider than a distance between sides of the opening is provided and secured into the groove using a spline.

In another embodiment, a flood guard for protecting an opening of a building from high water is disclosed including one or more frame sections having a groove extending longitudinally across an outer surface and an impermeable sheet sized to cover at least a lower portion of the opening. A spline is provided to removably hold the impermeable sheet in the groove, thereby covering the opening of the building and preventing high-water from entering the building.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a view of a system of all embodiments of the present invention in use.

FIG. 2 illustrates an exploded cross section view of the first embodiment of the present invention.

FIG. 3 illustrates a cross section view of the first embodiment of the present invention.

FIG. 4 illustrates a cross section view of a second embodiment of the present invention.

FIG. 5 illustrates a cross section view of a third embodiment of the present invention.

FIG. 6 illustrates a cross section view of a fourth embodiment of the present invention.

FIG. 7 illustrates an isometric view of the first embodiment of the present invention.

FIG. 8 illustrates an isometric view of the first embodiment of the present invention with a front-facing groove.

FIG. 9 illustrates an isometric view of the first embodiment of the present invention with an optional rain guard ready for installation.

FIG. 10 illustrates an isometric view of the first embodiment of the present invention with the optional rain installed.

FIG. 11 illustrates an isometric view of a flexible frame section a third embodiment of the present invention with optional corner pieces.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

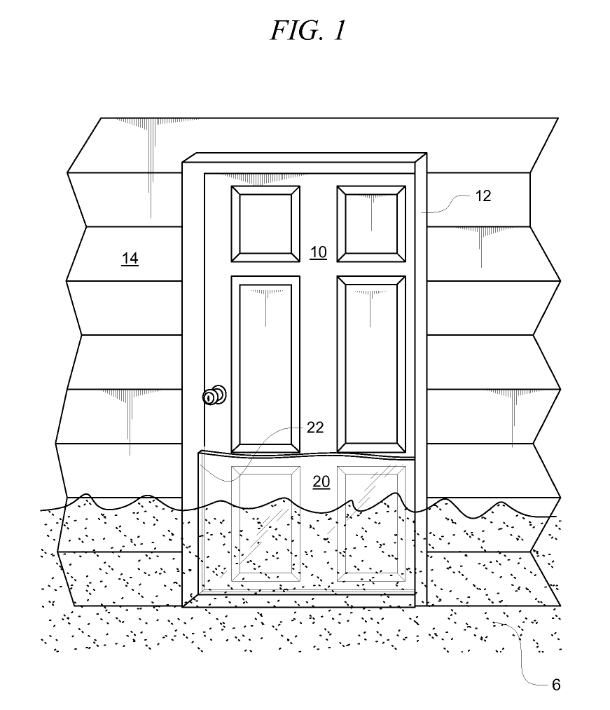

Referring to FIG. 1, a view of a system of all embodiments of the present invention in use is shown. In this, high-water 6 has invaded a house or other building structure 14. If left unprotected, the high-water 6 would normally enter the building 14 through cracks and spaces between the door 10 and the door frame 12. The present invention is shown preventing the high-water 6 from penetrating the door 10 by way of a flexible, impermeable sheet 20 that is removably affixed to a track or groove 22. The groove 22 longitudinally covers the bottom of the opening (doorway or window) and a portion of the lower sides so that the sheet 20 protects from high-water but the door or window isn't completely covered allowing escape in the event of a fire or other reason. The advantages of the present invention include easy and quick installation as well as efficient storage since only the flexible, impermeable sheet 20 need be stored when not in use.

Referring to FIG. 2, an exploded cross section view of the first embodiment of the present invention is shown. Installation is preferably performed in two steps. The first step is before any storm is predicted. At this time, the frame sections 22 are installed around the bottom three sides of any door or window needing protection from high-water. In the preferred installation of the frame sections 22, the door/window frame 12 is prepared with a layer of caulking 21 and the frame sections 22 are affixed to the door/window frame 12 with fasteners such as screws or nails 26. The caulk 21 is any caulk suitable for outdoor use such that prevents water penetration behind the frame sections 22, for example silicon caulk. The frame sections 22 are made from any suitable framing material such as wood, durable plastic, metal and aluminum, and are optionally finished to match the décor of the window/entryway. In an alternate embodiment, the frame sections 22 are integral portions of the initial door/window 10 frame and threshold, in that, the groove 28 is pre-cut in the door/window frame/threshold, thereby creating a door/window 10 that is ready to accept a water-lock barrier 20.

Independent of whether the initial door frame 12 and threshold include the groove 28 or a separate frame sections 22 have been installed, when high-water is predicted, the home or business owner prepares by installing the water-lock barrier 20. The water-lock barrier 20 is sized larger than the distance between the side grooves 28. The water-lock barrier 20 is installed by capturing an edge surface in the groove 28 with a spline 24, similar but different to how many screens are held in screen doors. Different, because the water-lock barrier 20 is not required to be pulled tightly between opposing sides of the frame, as is a screen. It is preferred that the water-lock barrier 20 be loosely fitted so that when the high-water 6 is present, the water-lock barrier 20 is pushed by the high-water 6 against the door or window, thereby providing structural support for the weight of the high-water 6. The spline 24 is preferable rounded for easy installation/removal and water barrier performance. In alternate embodiments, the spline 24 is oval or any suitable shape. In some embodiments, the spline 24 is smooth while, in others, it is textured or grooved. The spline 24 is preferably made from a flexible, durable, compressible material such as rubber. In alternate embodiments, the water-lock barrier 20 is thick enough and compressible so that the spline 24 need not be compressible, e.g., the spline 24 is installed into the groove 28 by compressing the water-lock barrier 20 and it passes through the narrows of the groove 28.

The water-lock barrier 20 is made from a material that is flexible and impermeable to water. Examples of such material are Mylar, vinyl, Visqueen and rubber. Any amount of stretching is acceptable, in that, as the water level rises, it is preferred that the water-lock barrier 20 protrude inward and rest against the door/window 10 for structural support. In situations where the door/window 10 cannot provide sufficient structural support as with French doors having glass in the lower areas, a stiff planar sheet is provided (not shown) between the water-lock barrier 20 and the door/window 10 for providing added structural support.

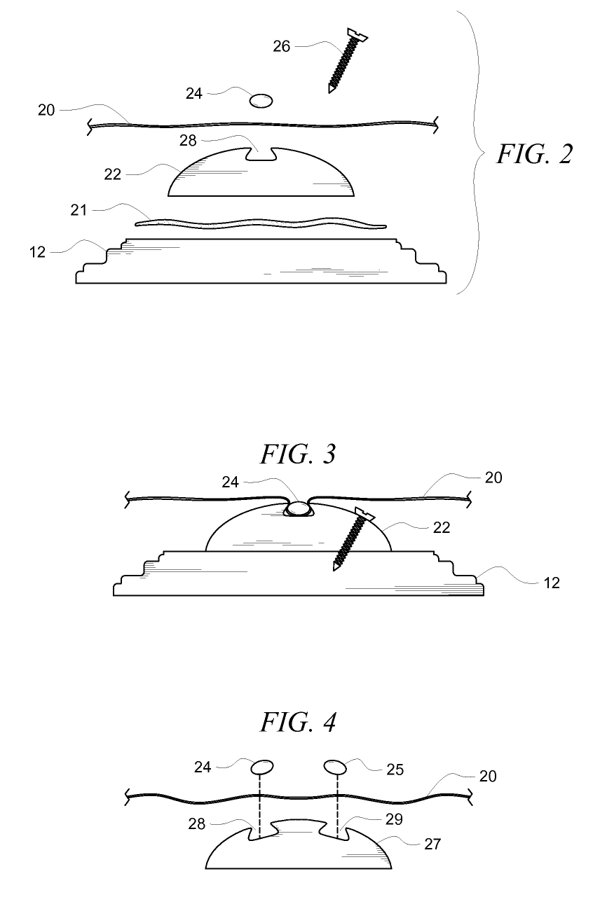

Referring to FIG. 3, a cross section view of the first embodiment of the present invention is shown. The frame sections 22 are already installed around the bottom three sides of any door or window needing protection from high-water. The layer of caulking 21 is no longer visible. An edge of the water-lock barrier 20 is captured in the groove 28 with a spline 24.

Referring to FIG. 4, a cross section view of a second embodiment of the present invention is shown. In this view, the frame 12, caulk 21 and fastener 26 are not shown for brevity purposes. In this embodiment, two grooves 28/29 are provided for added strength and to provide a better water seal. In this, the water-lock barrier 20 is held in place by two splines 24/25. Although one or two grooves 28/29 and slines 24/25 are preferred, it is anticipated that any number is possible.

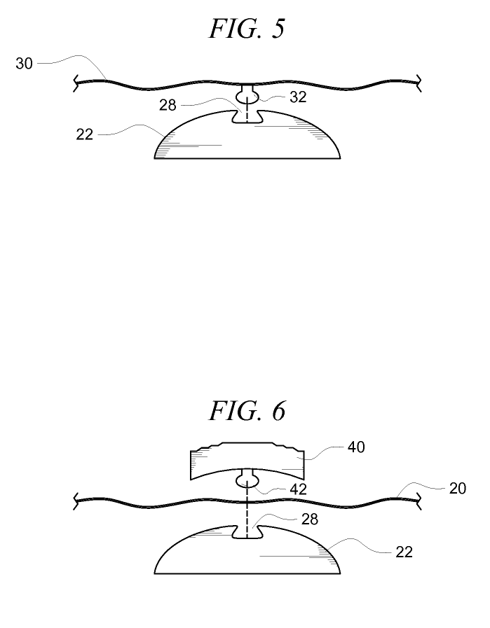

Referring to FIG. 5, a cross section view of a third embodiment of the present invention is shown. In this view, the frame 12, caulk 21 and fastener 26 are not shown for brevity purposes. In this embodiment, one groove 28 is provided and the spline 32 is an integral part of the water-lock barrier 30.

Referring to FIG. 6, a cross section view of a fourth embodiment of the present invention is shown. In this view, the frame 12, caulk 21 and fastener 26 are not shown for brevity purposes. In this embodiment, one groove 28 is provided and the spline 42 is an integral part of a decorative sheet 40. The decorative sheet 40 is constructed of a sheet of material such as metal, plastic or wood decorated to match the décor of the entryway/window so that, when there is no threat of high-water 6, the water-lock barrier 20 is removed and the decorative sheet 40 is re-installed into the groove 28, thereby covering and preventing dirt buildup in the groove 28.

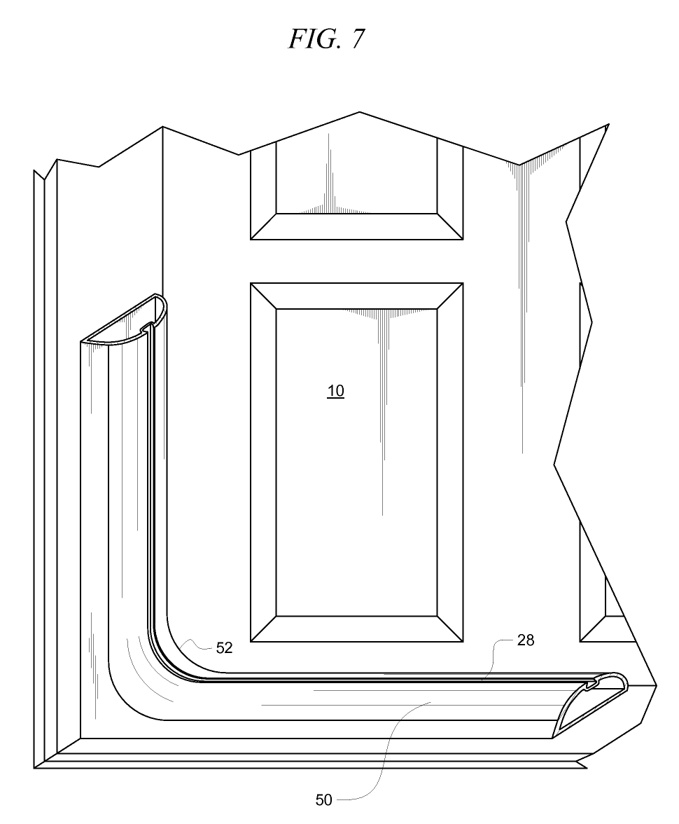

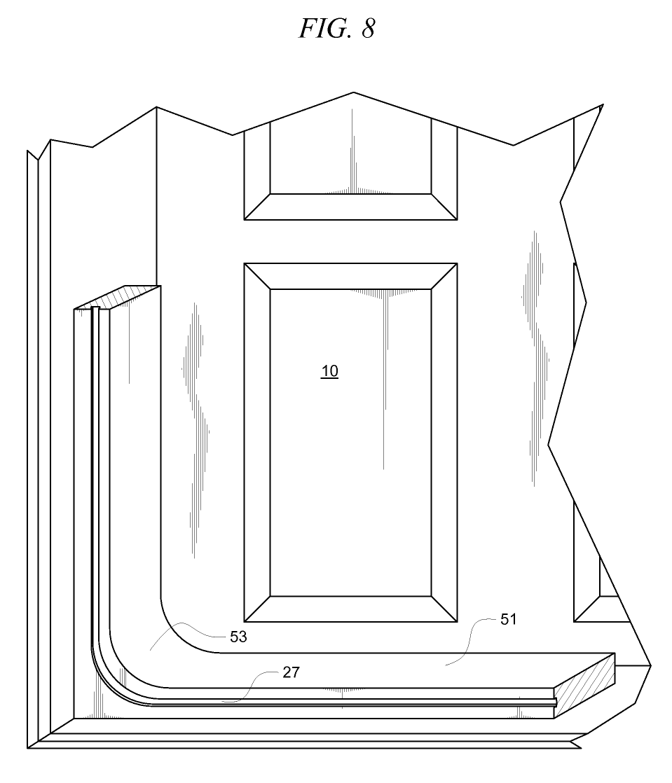

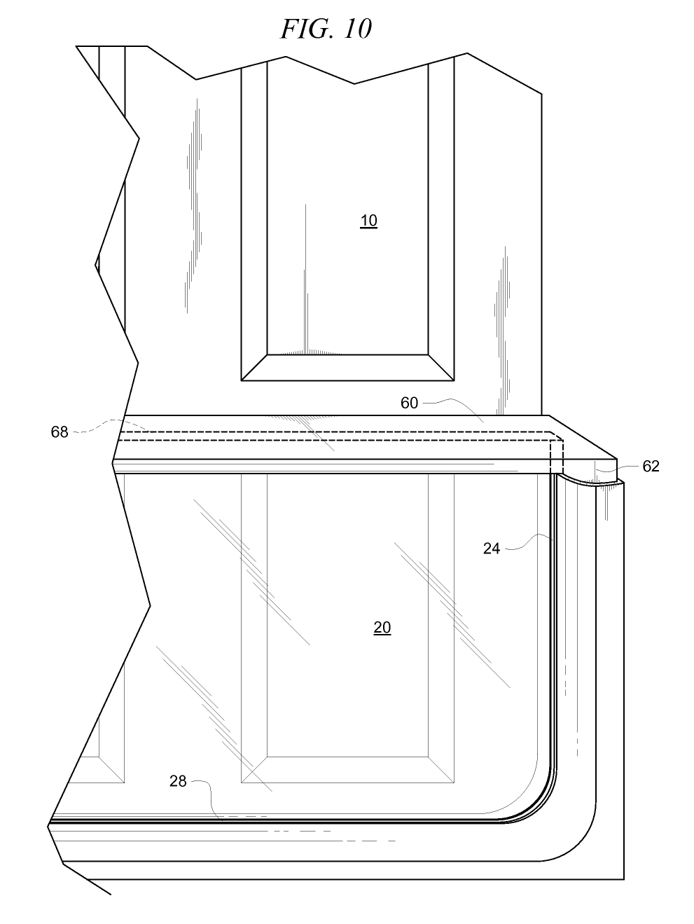

Referring to FIG. 7, an isometric view of the first embodiment of the present invention is shown installed in an entryway. In this example, the frame section 50 is made from a metal such as aluminum and is hollow, allowing multiple sections to be assembled together by telescoping the end of one section into another end of the other section. In this embodiment, the corner 52 of the frame section 50 has a radius to make it easier to install and remove the spline 24 into the longitudinal groove 28. In some embodiments, the frame section 50 is fabricated in as a left corner frame section (as shown) and a right corner frame section (shown in FIG. 10).

Referring to FIG. 8, an isometric view of the first embodiment of the present invention with a front-facing groove is shown. In this example, the frame section 51 is made from a solid material such as wood, plastic or stiff rubber. In this example, the frame sections 51 are either pre-cut to fit an existing door/window frame or are trimmed during installation. In this embodiment, the groove 27 is formed longitudinally in the face of the frame section 51 instead of the top/side as previously described. In such, the groove 27 is more visible than the previous embodiments (groove 28), but is less prone to dirt accumulation. In this embodiment, the corner 53 of the frame section 51 has a radius to make it easier to install and remove the spline 24 into the groove 27.

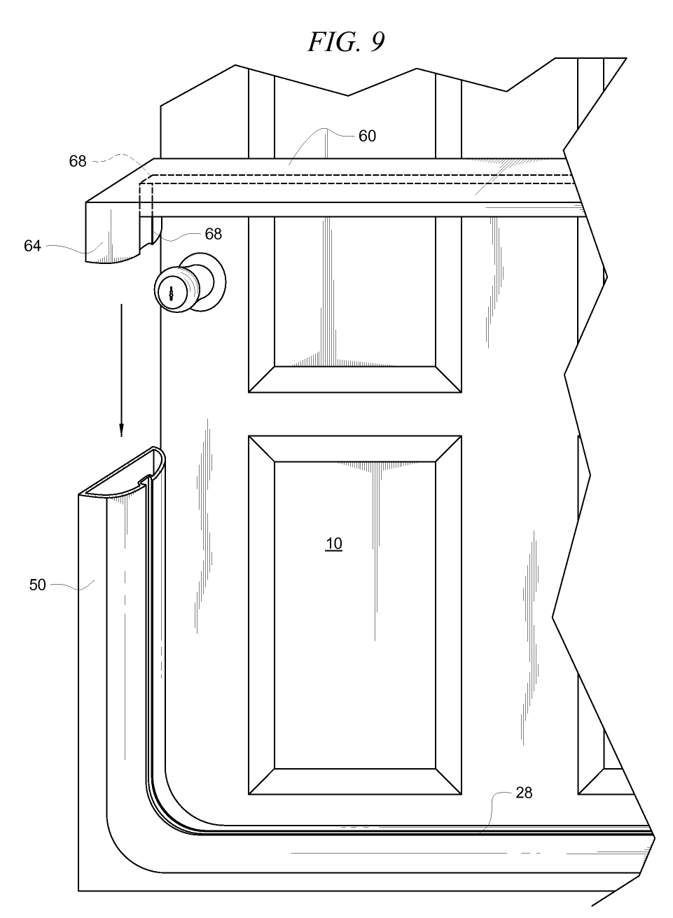

Referring to FIG. 9, an isometric view of the first embodiment of the present invention with an optional rain guard ready for installation is shown. Because the water-lock barrier 20 preferably does not cover the entire window/door 10, there is the possibility that rain and wind can accumulate behind the water-lock barrier 20, possibly causing leakage of rain water into the building or tearing of the water-lock barrier 20 from strong winds. One solution to this problem is a simple layer of tape applied to the top edge of the water-lock barrier 20, holding it against the door/window 10. Another solution, as shown in FIGS. 9/10, a rain guard insert 60 is provided for installation into the top of the frame section 50. The top surface of the rain guard 60 extends rearward sufficiently to touch or encroach upon the door/window 10, thereby providing a sufficient seal protecting from rain water and wind. The rain guard 60 has a groove 68 for capturing the water-lock barrier 20 with the use of the spline 24. In the preferred installation, an edge of the water-lock barrier 20 is first placed against the rain guard groove 68 and a spline 24 is inserted into the groove 68, capturing the water-lock barrier 20 in the groove 68. Then the downward extensions 64 of the rain guard 60 are inserted into the top of the frame sections 50 and the water-lock barrier 20 is captured in the groove 28 with a spline 24. FIG. 10 shows the water-lock barrier 20 installed with a rain guard 60.

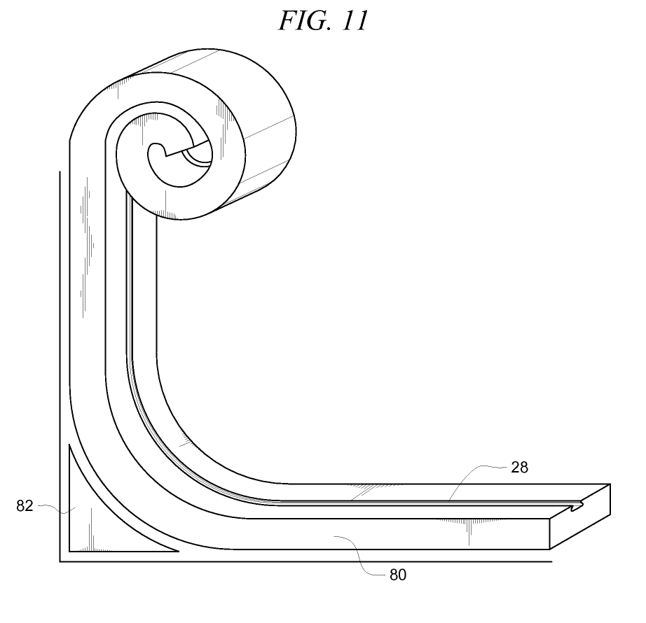

Referring now to FIG. 11, a flexible frame section 80 is shown. Often, door/window openings are not made to standard sizes. To avoid trimming and joining multiple sections of frame sections 22/27/50, this embodiment includes a flexible continuous frame section 80 that need be cut only once to fit in the desired opening. The flexible frame section 80 is preferably made from a bendable rubber material that is rigid enough for the spline 24 to capture the water-lock barrier 20 in its groove 28. The flexible frame section 80 is installed in a similar manner as the frame sections 22/27/50 using caulk 21 and fasteners 26. Although it is possible to caulk the corners where the flexible frame section 80 must bend 90 degrees, it is preferred to use a corner radius 82 caulked on its side that interfaces with the flexible frame section 80 and on its side that interfaces with the door/window frame.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A flood guard for protecting an opening of a building from high water, the flood guard comprising:
a groove extending longitudinally across a front of the opening of the building and partially up each of two sides of the opening;
an impermeable sheet sized to cover at least a lower portion of the opening; and
a spline adapted to removably hold the impermeable sheet in the groove, thereby at least partially covering the opening of the building and preventing high-water from entering the building through the opening.

2. The flood guard of claim 1, wherein the opening is a doorway and the groove is formed in a threshold of the doorway and side framing members of the doorway.

3. The flood guard of claim 1, wherein the groove is in a frame section and the frame section is affixed to the bottom and sides of the opening.

4. The flood guard of claim 1, wherein the impermeable sheet is made of a material selected from the group consisting of rubber, vinyl and Mylar.

5. The flood guard of claim 3, further comprising a rain guard removably affixed to top ends of the frame section, thereby at least partially covering an opening between the impermeable sheet and a door within the opening.

6. A method of protecting an opening of a building from high-water, the method comprising:
affixing a frame section around a lower outside perimeter of the opening, the frame section having at least one exposed groove extending longitudinally from one end of the frame section to a distal end of the frame section;
providing an impermeable sheet that is wider than a distance between sides of the opening; and
securing the impermeable sheet into the groove using a spline.

7. The method of claim 6, wherein the step of affixing includes the steps of:
placing a bead of caulk between the frame section and the lower outside perimeter of the opening; and
using a plurality of fasteners to affix the frame section to the lower outside perimeter of the opening.

8. The method of claim 6, further comprising the steps of:
providing a rain guard having a width slightly less than the distance between the sides of the opening and having a rain guard groove running longitudinally on an underside of the rain guard; and
before the step of securing:
securing a top edge of the impermeable sheet into the rain guard groove using the spline; and
affixing the rain guard to the one end of the frame section and to the distal end of the frame section.

9. The method of claim 6, wherein the impermeable sheet is made from a material selected from the group consisting of rubber, vinyl and Mylar.

10. The method of claim 6, wherein the frame section comprises a plurality of frame section pieces.

11. The method of claim 7, wherein the frame section is continuous and bendable; and the step of affixing further includes before the step of placing, the step of:
affixing a corner radius in each of two lower corners of the opening in line with a location in which the frame section is to be affixed.

12. A flood guard for protecting an opening of a building from high water, the flood guard comprising:
one or more frame sections having a groove extending longitudinally across an outer surface of the frame section;
an impermeable sheet sized to cover at least a lower portion of the opening; and
a spline adapted to removably hold the impermeable sheet in the groove, thereby covering the opening of the building and preventing the high-water from entering the building.

13. The flood guard of claim 12, wherein the one or more frame sections interlock with each other.

14. The flood guard of claim 12, wherein the one or more frame sections is one continuous frame section.

15. The flood guard of claim 14, wherein the flood guard further comprises two corner radiuses.

16. The flood guard of claim 12, wherein the one or more frame sections include a left corner frame section and a right corner frame section.

17. The flood guard of claim 12, wherein the frame sections are adapted to frame at least a lower portion of the opening.

18. The flood guard of claim 12, wherein the impermeable sheet is made of a material selected from the group consisting of rubber, vinyl and Mylar.

19. The flood guard of claim 12, further comprising a rain guard removably affixed to top ends of the frame section, thereby at least partially covering an opening between the impermeable sheet and a door within the opening.
